(19) United States
(12) Patent Application Publication
(10) Pub. No.: US 2025/0110698 A1
(43) Pub. Date: Apr. 3, 2025

(54) DEVICE AND METHOD FOR PIPELINED MULTIPLY-ACCUMULATOR

(71) Applicant: Microchip Technology Incorporated, Chandler, AZ (US)

(72) Inventor: Chris Norrie, Castro Valley, CA (US)

(73) Assignee: Microchip Technology Incorporated, Chandler, AZ (US)

(21) Appl. No.: 18/653,733

(22) Filed: May 2, 2024

Related U.S. Application Data
(60) Provisional application No. 63/541,096, filed on Sep. 28, 2023.

(51) Int. Cl. G06F 7/57; G06F 7/544

(52) U.S. Cl. CPC G06F 7/57; G06F 7/5443

(57) ABSTRACT

A circuit may include a vector arithmetic logic unit (ALU), the vector ALU comprising a multiplier, a first multiplexer, a second multiplexer and an accumulator. The vector ALU may compute a dot product of two or more vector inputs. A system may include two or more vector ALUs, and may partition a vector input into multiple segments. Each segment may be input to a respective vector ALU via a multiplexer, and a controller may route the partial sums of respective ALUs via one or more feedback paths and the system may compute the complete dot product of the vector inputs.

### PRIORITY

This application claims priority to commonly owned U.S. patent application Ser. No. 63/541,096 filed on Sep. 28, 2023, the entire contents of which are hereby incorporated by reference for all purposes.

### FIELD OF THE INVENTION

The present disclosure relates to multiply-accumulator circuits and methods, more particularly to a device and method for a pipelined multiply-accumulator.

### BACKGROUND

Mathematical algorithms may require the use of dot product operations. As one of various examples, in machine learning applications, the dot product operation may comprise the bulk of the arithmetic operations in the machine learning algorithm. Processors implemented on Application Specific Integrated Circuits (ASICs) and Field-Programmable Gate Arrays (FPGAs) may include support for machine learning and may execute multiple dot product operations. Efficient computation of the dot product may be a critical performance parameter in these systems.

The dot product operation is a vector multiply and add operation. The following equation defines the dot product of two vectors, A and B, of length N:

$${\sum }_{i = 1}^{N} {A}_{i} * {B}_{i}$$

Respective samples of vectors A and B are multiplied, and products are successively added to previous products to yield a single scalar output. In one of various examples, a hardware multiply-accumulator may multiply vector values and add new multiplication outputs to successively compute the dot product result.

The multiply and accumulate arithmetic operations may consume varying numbers of cycles such that it can be difficult to fully utilize available cycles in a pipelined operation. In floating-point systems, an accumulator may involve both a shift operation and an addition operation, which may increase the cycle time of the accumulator.

There is a need for a pipelined multiply-accumulator for high-speed dot product computation.

### SUMMARY

The examples herein enable a system for a pipelined multiply-accumulator.

According to one aspect, a device may include a vector arithmetic logic unit (ALU) comprising at least two vector inputs. The vector ALU also comprising a multiplier to take input from the at least two vector inputs and to produce a multiplier output comprising a product of the at least two vector inputs. The vector ALU also comprising a first multiplexer to select, as a first multiplexer output, one of the multiplier output, an external input and a feedback output. The vector ALU also comprising a second multiplexer to select, as a second multiplexer output one of the external input and a feedback output. The vector ALU also comprising an accumulator to add the first multiplexer output and the second multiplexer output to generate the feedback output.

According to one aspect, a system includes a multiplexer to receive two or more vector inputs. The system includes at least one vector arithmetic logic unit (ALU) to receive at least one output of the multiplexer. The at least one vector ALU may include at least two ALU vector inputs, the ALU vector inputs provided by the multiplexer. The at least one vector ALU may include a multiplier to take input from the at least two ALU vector inputs and to produce a multiplier output comprising a product of the at least two ALU vector inputs. The at least one vector ALU may include an accumulator to take input from the multiplier output and a feedback output, wherein the accumulator adds the multiplier output and the feedback output. The at least one vector ALU may include a controller with an output feedback signal coupled to the multiplexer, the controller to receive input from the at least one vector ALU and to generate a feedback signal based on the output of the at least one vector ALU.

According to one aspect, a method includes steps of: partitioning a first vector and a second vector into one or more segments, coupling the segments of the first vector and the second vector to one or more vector ALUs, the vector ALUs comprising at least a multiplier and an accumulator, computing a dot product of the segments of the first vector and the second vector by pipelining even-numbered samples and odd-numbered samples within the one or more vector ALUs, and adding an output of the one or more vector ALUs to compute the dot product of the first vector and the second vector.

### BRIEF DESCRIPTION OF THE DRAWINGS

FIG. 1 illustrates one of various examples of a vector ALU device.

FIG. 2 illustrates one of various examples of a pipelined multiply accumulator system for computing a dot product.

FIG. 3 illustrates a timing diagram of a vector ALU device.

FIG. 4 illustrates a method for computation of a dot product.

### DETAILED DESCRIPTION

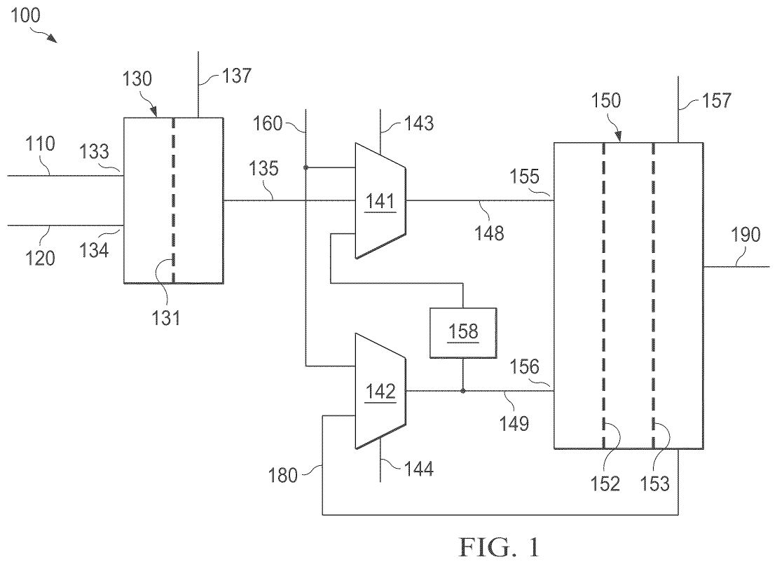

FIG. 1 illustrates one of various examples of a vector ALU 100. Vector ALU 100 may comprise a multiply-accumulator circuit.

Vector ALU 100 may include multiplier 130. A first input 110 may be coupled to a first operand input 133 of multiplier 130. A second input 120 may be coupled to a second operand input 134 of multiplier 130. Multiplier 130 may include clock signal input 137.

In operation, multiplier 130 may generate a multiplier output. The multiplier output may be a product 135 comprising an arithmetic product of the first operand input 133 and second operand input 134. Dashed vertical line 131 may represent a cycle time of multiplier 130. Product 135 may be output 1 clock cycle after first input 110 and second input 120 are input to multiplier 130. First input 110 and second input 120 may be input to multiplier 130 at a first clock cycle, and product 135 may be valid at a second clock cycle. In other examples, product 135 may be valid after a different number of cycles.

First input 110 and second input 120 may be a sequence of samples, each arriving at multiplier 130 at a rate of one sample per clock signal input 137.

External input 160 may be coupled to a first input of first multiplexer 141. Product 135 may be coupled to a second input of first multiplexer 141. First select signal 143 may select one of the inputs of first multiplexer 141 to couple to first multiplexer output 148.

External input 160 may be coupled to a first input of second multiplexer 142. Feedback output 180 may be coupled to a second input of second multiplexer 142. Second select signal 144 may select one of the inputs of second multiplexer 142 to couple to second multiplexer output 149.

Accumulator 150 may include a first operand input 155 and a second operand input 156. Accumulator 150 may include clock signal input 157.

In operation, accumulator 150 may output an accumulator output 190, accumulator output 190 comprising an arithmetic sum of first operand input 155 and second operand input 156. Dashed vertical lines 152 and 153 may represent a cycle time of accumulator 150, and in the example illustrated in FIG. 1, may indicate that accumulator 150 may comprise a 3-cycle accumulator. Accumulator output 190 may therefore be output 2 clock cycles after first multiplexer output 148 and second multiplexer output 149 are input to accumulator 150. Accumulator 150 may output a feedback output 180, feedback output 180 comprising an arithmetic sum of first operand input 155 and second operand input 156. Feedback output 180 may be output 2 clock cycles after first multiplexer output 148 and second multiplexer output 149 are input to accumulator 150. In other examples, the timing of feedback output 180 may be different from the example illustrated in FIG. 1.

In operation, vector ALU 100 may implement a dot product operation. As one of various examples, vector ALU 100 may compute the dot product of a first vector A and second vector B. First vector A may be a first sequence of samples. Second vector B may be a second sequence of samples. Vector ALU 100 may process sampled data, successive samples of data processed in discrete time periods, the time periods defined by clock signal input 137.

At a first time period, a first sample of vector A may be coupled to first input 110 and a first sample of vector B may be coupled to second input 120. Multiplier 130 may compute a product 135 of the first sample of vector A and the first sample of vector B as product 135. Product 135 of the first sample of vector A and the first sample of vector B may be valid during a second time period. The second time period may be after the first time period. First multiplexer 141 may couple product 135 to first multiplexer output 148. During the second time period, external input 160 may be set to logic zero, and second multiplexer 142 may couple external input 160 to second multiplexer output 149. Accumulator 150 may compute the sum of first multiplexer output 148 and second multiplexer output 149 and provide the computed sum at feedback output 180. Feedback output 180 may represent a product of the first sample of vector A and the first sample of vector B and may be valid at a fourth time period.

At the second time period, which second time period is prior to the third time period, a second sample of vector A may be coupled to first input 110 and a second sample of vector B may be coupled to second input 120. Multiplier 130 may compute a product of the second sample of vector A and the second sample of vector B as product 135. Product 135 of the second sample of vector A and the second sample of vector B may be valid during a third time period. First multiplexer 141 may couple product 135 to first multiplexer output 148. At the third time period, first select signal 143 may direct first multiplexer 141 to select product 135, and second multiplexer 142 may couple external input 160 to second multiplexer output 149. External input 160 may be set to zero. Accumulator 150 may compute the sum of first multiplexer output 148 and second multiplexer output 149 and provide the computed sum at feedback output 180. Feedback output 180 may represent a product of the second sample of vector A and the second sample of vector B and may be valid at a fifth time period.

At the third time period, which third time period is prior to a fourth time period, a third sample of vector A may be coupled to first input 110 and a third sample of vector B may be coupled to second input 120. Multiplier 130 may compute a product of the third sample of vector A and the third sample of vector B as product 135. Product 135 of the third sample of vector A and the third sample of vector B may be valid during a fourth time period. First multiplexer 141 may couple product 135 to first multiplexer output 148. At the fourth time period, feedback output 180 may represent the sum of the first sample of vector A and the first sample of vector B. At the fourth time period and subsequent time periods or subsequent clock cycles, second multiplexer 142 may couple feedback output 180 to second multiplexer output 149. Accumulator 150 may compute the sum of first multiplexer output 148 and second multiplexer output 149 as feedback output 180. This feedback output may represent the sum of two values: a product of the first sample of vector A and the first sample of vector B, input from second multiplexer output 149, and a product of the third sample of vector A and the third sample of vector B, input from first multiplexer output 148. In this manner, the dot product of the odd-numbered samples (first sample, third sample, fifth sample, and following) of vector A and vector B may be computed in a pipelined operation, and the dot product of the even-numbered samples (second sample, fourth sample, sixth sample, and following) of vector A and vector B may be computed in a pipelined operation.

Similar multiply and add operations may continue for additional samples of vector A and vector B. The pipeline may compute the partial sum of the even-numbered samples in one pipeline stage and may compute the partial sum of the odd-numbered samples in a second pipeline stage.

During the first time period, the first samples of vector A and vector B may be processed by vector ALU 100. During the second time period, the second samples of vector A and vector B may be processed by vector ALU 100. During a fourth time period, feedback output 180 may represent the sum of values processed during the first time period, since the feedback output 180 is valid after two clock cycles. Similarly, during a fifth time period, feedback output 180 may represent the sum of values processed during the second time period, since the feedback output 180 is valid after two clock cycles. In this manner, vector ALU 100 may implement a pipelined multiply-accumulator. Vector ALU 100 may process odd-numbered samples and may process even-numbered samples of the two input vectors in alternating cycles.

When the last sample of vector A and vector B are input to vector ALU 100, the even-numbered samples and odd-numbered samples may be added together to compute the complete dot product of vector A and vector B. At a next-to-last cycle, feedback output 180 may be the partial sum of all odd-numbered samples. At a last cycle, the last cycle after the next-to-last cycle, feedback output 180 may be the partial sum of all the even-numbered samples. At the last cycle, first multiplexer 141 may select the output of delay cell 158 and couple the output of delay cell 158 to first multiplexer output 148. The output of delay cell 158 may be the previous value of feedback output 180, specifically the partial sum of all the odd-numbered samples. The output of delay cell 158 may be a delay signal. Accumulator 150 may add the partial sum of the odd-numbered samples and the partial sum of the even-numbered samples to generate the dot product.

FIG. 1 illustrates an example with a feedback output valid after two clock cycles.

Operation of vector ALU 100 may be controlled by software operating in a microcontroller or microprocessor or may be controlled by dedicated hardware.

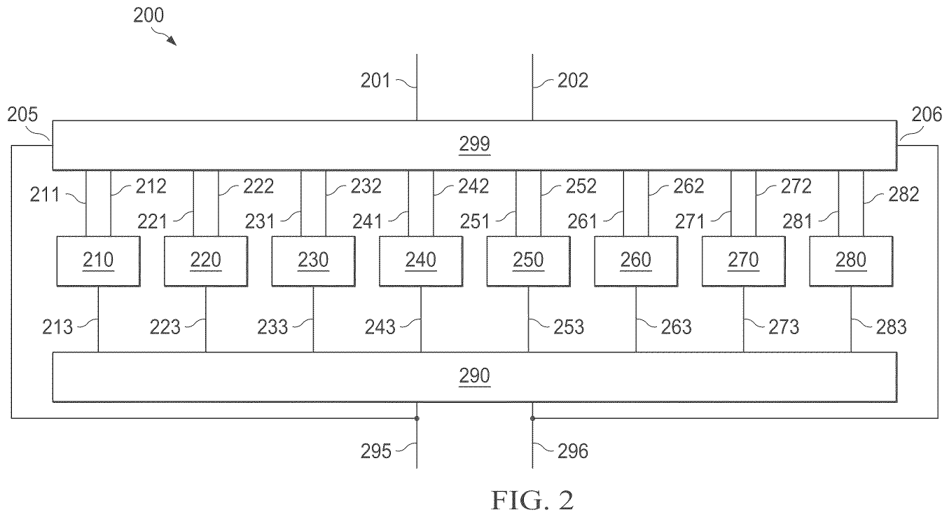

FIG. 2 illustrates one of various examples of a pipelined multiply-accumulator system 200 for computing a dot product. In the example illustrated in FIG. 2, a dot product operation may be partitioned into 8 parallel arithmetic logic units (ALUs), 210, 220, 230, 240, 250, 260, 270 and 280. ALUs 210, 220, 230, 240, 250, 260, 270 and 280 may be vector ALUs as described and illustrated in reference to FIG. 1. ALUs 210, 220, 230, 240, 250, 260, 270, and 280 may include other arithmetic operations and computational units not specifically disclosed or described. A clock signal (not shown) may control operation of system 200 and a clock cycle may be defined as a period of the clock signal.

Inputs to respective ALUs may be provided from a first vector input 201 and a second vector input 202. Inputs to respective ALUs may be ALU vector inputs. Portions of first vector input 201 and second vector input 202 may be routed to one of more ALUs by multiplexer 299. Portions of first vector input 201 and second vector input 202 may comprise one or more samples.

Multiplexer 299 may include feedback input 205 and feedback input 206 which may be routed to one or more of ALU vector inputs 211, 212, 221, 222, 231, 232, 241, 242, 251, 252, 261, 262, 271, 272, 281 and 282.

ALU vector input 211 and ALU vector input 212 may be coupled to first ALU 210. First ALU 210 may implement one or more arithmetic operations, including but not limited to multiply-accumulate operations, and may generate first ALU output 213. First ALU output 213 may be input to controller circuit 290. ALU vector input 221 and ALU vector input 222 may be coupled to second ALU 220. Second ALU 220 may implement one or more arithmetic operations, including but not limited to multiply-accumulate operations, and may generate second ALU output 223. Second ALU output 223 may be input to controller circuit 290. ALU vector input 231 and ALU vector input 232 may be coupled to third ALU 230. Third ALU 230 may implement one or more arithmetic operations and may generate third ALU output 233. Third ALU output 233 may be input to controller circuit 290. ALU vector input 241 and ALU vector input 242 may be coupled to fourth ALU 240. Fourth ALU 240 may implement one or more arithmetic operations and may generate fourth ALU output 243. Fourth ALU output 243 be input to controller circuit 290.

ALU vector input 251 and ALU vector input 252 may be coupled to fifth ALU 250. Fifth ALU 250 may implement one or more arithmetic operations and may generate fifth ALU output 253. Fifth ALU output 253 may be input to controller circuit 290. ALU vector input 261 and ALU vector input 262 may be coupled to sixth ALU 260. Sixth ALU 260 may implement one or more arithmetic operations and may generate sixth ALU output 263. Sixth ALU output 263 may be input to controller circuit 290. ALU vector input 271 and ALU vector input 272 may be coupled to seventh ALU 270. Seventh ALU 270 may implement one or more arithmetic operations and may generate seventh ALU output 273. Seventh ALU output 273 may be input to controller circuit 290. ALU vector input 281 and ALU vector input 282 may be coupled to eighth ALU 280. Eighth ALU 280 may implement one or more arithmetic operations and may generate eighth ALU output 283. Eighth ALU output 283 may be input to controller circuit 290.

ALU vector inputs 211, 212, 221, 222, 231, 232, 241, 242, 251, 252, 261, 262, 271, 272, 281 and 282 may be driven simultaneously, such that ALUs 210, 220, 230, 240, 250, 260, 270 and 280 may operate in parallel.

Controller circuit 290 may include arithmetic circuits, multiplexers and other circuits to perform arithmetic operations on one or more inputs and to route one or more inputs to output 295 and output 296. Outputs 295 and 296 may connect to any of ALU vector inputs 211, 212, 221, 222, 231, 232, 241, 242, 251, 252, 261, 262, 271, 272, 281, 282 via multiplexer 299. Output 295 and output 296 may be termed feedback signals.

In operation, system 200 may implement a dot product. An input vector may be partitioned into 8 segments and distributed in parallel between first ALU 210, second ALU 220, third ALU 230, fourth ALU 240, fifth ALU 250, sixth ALU 260, seventh ALU 270, and eighth ALU 280 by multiplexer 299. In one of various examples, system 200 may implement a dot product of two input vectors, vector A and vector B. Vector A may have 1024 samples, though this is not intended to be limiting. Vector B may have 1024 samples, though this is not intended to be limiting. Vector A and vector B may have an equal number of samples. Individual samples of vector A and vector B may be addressed by an index value. As one of various examples, the first sample of vector A may be addressed by an index value of 1 and the first sample of vector B may be addressed by an index value of 1. In other examples a first sample of vector A may be addressed by an index value of 0 and a first sample of vector B may be addressed by an index value of 0. Vector A may be partitioned into 8 segments of 128 samples, and segments may be input to one of the ALUs by multiplexer 299. Vector B may be partitioned into 8 segments of 128 samples, and segments may be input to one of the ALUs by multiplexer 299. Segments may be formed sequentially as samples arrive, but this is not intended to be limiting, such that a first segment of vector A may contain a first sample of vector A, a second segment may contain a second sample of vector A, and continuing sequentially through all samples of vector A and all segments. Similarly, a first segment of vector B may contain a first sample of vector B, a second segment may contain a second sample of vector B, and continuing sequentially through all samples of vector B and all segments.

A partial sum may be defined as a dot product of one segment of vector inputs. In the example illustrated in FIG. 2, vector A and vector B may be partitioned into 8 segments, and eight partial sums may be computed. In the example illustrated in FIG. 2, respective ALUs may compute partial sums of respective segments of vector A and vector B.

In one of various examples, a first segment of vector A may be coupled to ALU vector input 211. A first segment of vector A may be comprised of samples from index value 1 to index value 128. A first segment of vector B may be coupled to ALU vector input 212. A first segment of vector B may be comprised of samples from index value 1 to index value 128. First ALU 210 may compute the dot product of the first segment of vector A and the first segment of vector B and may output the dot product at first ALU output 213. The dot product at first ALU output 213 may be a partial sum. First ALU 210 may perform a pipelined multiply accumulator and may process even samples and odd samples in separate streams.

A second segment of vector A may be coupled to ALU vector input 221. A second segment of vector A may be comprised of samples from index value 129 to index value 256. A second segment of vector B may be coupled to ALU vector input 222. A second segment of vector B may be comprised of samples from index value 129 to index value 256. Second ALU 220 may compute the dot product of the second segment of vector A and the second segment of vector B and may output the dot product at second ALU output 223. The dot product at second ALU output 223 may be a partial sum. Second ALU 220 may perform a pipelined multiply accumulator and may process even samples and odd samples in separate streams.

A third segment of vector A may be coupled to ALU vector input 231. A third segment of vector A may be comprised of samples from index value 257 to index value 384. A third segment of vector B may be coupled to ALU vector input 232. A third segment of vector B may be comprised of samples from index value 257 to index value 384. Third ALU 230 may compute the dot product of the third segment of vector A and the third segment of vector B and may output the dot product at output 233. The dot product at third ALU output 233 may be a partial sum. Third ALU 230 may perform a pipelined multiply accumulator and may process even samples and odd samples in separate streams.

A fourth segment of vector A may be coupled to ALU vector input 241. A fourth segment of vector A may be comprised of samples from index value 385 to index value 512. A fourth segment of vector B may be coupled to ALU vector input 242. A fourth segment of vector B may be comprised of samples from index value 385 to index value 512. Fourth ALU 240 may compute the dot product of the fourth segment of vector A and the fourth segment of vector B and may output the dot product at fourth ALU output 243. The dot product at fourth ALU output 243 may be a partial sum. Fourth ALU 240 may perform a pipelined multiply accumulator and may process even samples and odd samples in separate streams.

A fifth segment of vector A may be coupled to ALU vector input 251. A fifth segment of vector A may be comprised of samples from index value 513 to index value 640. A fifth segment of vector B may be coupled to ALU vector input 252. The fifth segment of vector B may be comprised of samples from index value 513 to index value 640. Fifth ALU 250 may compute the dot product of the fifth segment of vector A and the fifth segment of vector B, and may output the dot product at fifth ALU output 253. The dot product at fifth ALU output 253 may be a partial sum. Fifth ALU 250 may perform a pipelined multiply accumulator and may process even samples and odd samples in separate streams.

A sixth segment of vector A may be coupled to ALU vector input 261. A sixth segment of vector A may be comprised of samples from index value 641 to index value 768. A sixth segment of vector B may be coupled to ALU vector input 262. A sixth segment of vector B may be comprised of samples from index value 641 to index value 768. Sixth ALU 260 may compute the dot product of the sixth segment of vector A and the sixth segment of vector B and may output the dot product at sixth ALU output 263. The dot product at sixth ALU output 263 may be a partial sum. Sixth ALU 260 may perform a pipelined multiply accumulator and may process even samples and odd samples in separate streams.

A seventh segment of vector A may be coupled to ALU vector input 271. The seventh segment of vector A may be comprised of samples from index value 769 to index value 896. A seventh segment of vector B may be coupled to ALU vector input 272. A seventh segment of vector B may be comprised of samples from index value 769 to index value 896. Seventh ALU 270 may compute the dot product of the seventh segment of vector A and the seventh segment of vector B, and may output the dot product at seventh ALU output 273. The dot product at seventh ALU output 273 may be a partial sum. Seventh ALU 270 may perform a pipelined multiply accumulator and may process even samples and odd samples in separate streams.

An eighth segment of vector A may be coupled to ALU vector input 281. An eighth segment of vector A may be comprised of samples from index value 897 to index value 1024. An eighth segment of vector B may be coupled to ALU vector input 282. The eighth segment of vector B may be comprised of samples from index value 897 to index value 1024. Eighth ALU 280 may compute the dot product of the eighth segment of vector A and the eighth segment of vector B, and may output the dot product at eighth ALU output 283. The dot product at eighth ALU output 283 may be a partial sum. Eighth ALU 280 may perform a pipelined multiply accumulator and may process even samples and odd samples in separate streams.

In the example illustrated in FIG. 2, each of ALUs 210, 220, 230, 240, 250, 260, 270 and 280 may compute the dot product of respective segments of vector A and vector B. Controller circuit 290 may control the outputs of ALUs 210, 220, 230, 240, 250, 260, 270 and 280 and may drive outputs 295 and 296 to compute the dot product of the entire vector A and vector B.

Controller circuit 290 may receive input from the output of the respective ALUs. The output of respective ALUs may be partial sums of the dot product, representing the dot product of one or more segments of vector inputs. Controller circuit 290 may utilize outputs 295 and 296 to route signals back to one or more ALUs via feedback input 205 and feedback input 206 of multiplexer 299 and may use one or more of the ALUs to perform the addition to generate the final dot product output. In one of various examples, first ALU output 213 may represent the dot product of the first 128 samples of vector A and vector B and second ALU output 223 may represent the dot product of the second 128 samples of vector A and vector B. Controller circuit 290 may couple first ALU output 213 to output 295, and multiplexer 299 may route output 295 to ALU vector input 211 via feedback input 205. Controller circuit 290 may couple second ALU output 223 to output 296 and multiplexer 299 may route output 296 to ALU vector input 212 via feedback input 206. First ALU 210 may sum ALU vector input 211 and ALU vector input 212.

Similarly, third ALU output 233 may represent the dot product of the third 128 samples of vector A and vector B and fourth ALU output 243 may represent the dot product of the fourth 128 samples of vector A and vector B. Controller circuit 290 may couple third ALU output 233 to output 295, and multiplexer 299 may route output 295 to ALU vector input 221 via feedback input 205. Controller circuit 290 may couple fourth ALU output 243 to output 296 and multiplexer 299 may route output 296 to ALU vector input 222 via feedback input 206. Second ALU 220 may sum ALU vector input 211 and ALU vector input 212.

Similarly, fifth ALU output 253 may represent the dot product of the fifth 128 samples of vector A and vector B and sixth ALU output 263 may represent the dot product of the sixth 128 samples of vector A and vector B. Controller circuit 290 may couple fifth ALU output 253 to output 295, and multiplexer 299 may route output 295 to ALU vector input 231 via feedback input 205. Controller circuit 290 may couple sixth ALU output 263 to output 296 and multiplexer 299 may route output 296 to ALU vector input 232 via feedback input 206. Third ALU 230 may sum ALU vector input 231 and ALU vector input 232.

Similarly, seventh ALU output 273 may represent the dot product of the seventh 128 samples of vector A and vector B and eighth ALU output 283 may represent the dot product of the eighth 128 samples of vector A and vector B. Controller circuit 290 may couple seventh ALU output 273 to output 295, and multiplexer 299 may route output 295 to ALU vector input 241 via feedback input 205. Controller circuit 290 may couple eighth ALU output 283 to output 296 and multiplexer 299 may route output 296 to ALU vector input 242 via feedback input 206. Fourth ALU 240 may sum ALU vector input 241 and ALU vector input 242.

Outputs of ALUs 210, 220, 230, 240, 250, 260, 270 and 280 may be computed simultaneously and in parallel, such that ALU outputs 213, 223, 233, 243, 253, 263, 273, and 283 may be computed simultaneously.

Controller circuit 290 may feedback outputs of respective ALUs to inputs of one or more ALUs. In this manner, controller circuit 290 may control multiplexer 299 and may compute a complete dot product of the entire vector A and vector B in one or more stages.

In one of various examples, during a first stage, controller circuit 290 may couple first ALU output 213 to output 295, and multiplexer 299 may route output 295 to ALU vector input 211 via feedback input 206. Controller circuit 290 may couple second ALU output 223 to output 296, and multiplexer 299 may route output 296 to ALU vector input 212 via feedback input 206. First ALU 210 may compute the sum of ALU vector input 211 and ALU vector input 212, and the sum may be output to first ALU output 213. First ALU output 213 may represent the dot product of the first 256 samples of vector A and vector B.

Controller circuit 290 may couple third ALU output 233 to output 295, and multiplexer 299 may route output 296 to ALU vector input 231 via feedback input 206. Controller circuit 290 may couple fourth ALU output 243 to output 296, and multiplexer 299 may route output 296 to ALU vector input 232. Third ALU 230 may compute the sum of ALU vector input 231 and ALU vector input 232, and the sum may be output to third ALU output 233. Third ALU output 233 may represent the dot product of the second 256 samples of vector A and vector B.

Controller circuit 290 may couple fifth ALU output 253 to output 295, and multiplexer 299 may route output 295 to ALU vector input 251 via feedback input 205. Controller circuit 290 may couple sixth ALU output 263 to output 296, and multiplexer 299 may route output 296 to ALU vector input 252 via feedback input 206. Fifth ALU 250 may compute the sum of ALU vector input 251 and ALU vector input 252, and the sum may be output to fifth ALU output 253. Fifth ALU output 253 may represent the dot product of the third 256 samples of vector A and vector B.

Controller circuit 290 may couple seventh ALU output 273 to output 295, and multiplexer 299 may route output 295 to ALU vector input 271 via feedback input 205. Controller circuit 290 may couple eighth output 283 to output 296, and multiplexer 299 may route output 296 to ALU vector input 272 via feedback input 206. Seventh ALU 270 may compute the sum of ALU vector input 271 and ALU vector input 272, and the sum may be output to seventh ALU output 273. Seventh ALU output 273 may represent the dot product of the fourth 256 samples of vector A and vector B.

In a similar manner, during a second stage following the first stage, first ALU output 213, third ALU output 233, fifth ALU output 253 and seventh ALU output 273 may be added to compute the dot product of the 1024 samples of vector A and vector B. Controller circuit 290 may couple first ALU output 213 to output 295, and multiplexer 299 may route output 295 to ALU vector input 211 via feedback input 205. Controller circuit 290 may couple third ALU output 233 to output 296, and multiplexer 299 may route output 296 to ALU vector input 212 via feedback input 206. First ALU 210 may compute the sum of ALU vector input 211 and ALU vector input 212, and the sum may be output to first ALU output 213. First ALU output 213 may represent the dot product of the first 512 samples of vector A and vector B. Controller circuit 290 may couple fifth ALU output 253 to output 295, and multiplexer 299 may route output 295 to ALU vector input 221 via feedback input 205. Controller circuit 290 may couple seventh ALU output 273 to output 296, and multiplexer 299 may route output 296 to ALU vector input 222 via feedback input 206. Second ALU 220 may compute the sum of ALU vector input 221 and ALU vector input 222, and the sum may be output to second ALU output 223. Second ALU output 223 may represent the dot product of the second 512 samples of vector A and vector B.

During a third stage following the second stage, controller circuit 290 may couple first ALU output 213 to output 295, and multiplexer 299 may route output 295 to ALU vector input 211 via feedback input 205. Controller circuit 290 may couple second ALU output 223 to output 296, and multiplexer 299 may route output 296 to ALU vector input 212 via feedback input 206. First ALU 210 may compute the sum of ALU vector input 211 and ALU vector input 212, and the sum may be output to first ALU output 213. First ALU output 213 may represent the dot product of all samples of vector A and vector B.

The example illustrated above is not intended to be limiting. In the example illustrated above, 3 stages are required to compute the complete dot product, but this is not intended to be limiting. Each of the first stage, second stage and third stage may be defined as one or more clock cycles. A dot product of vectors of sizes other than 1024 samples may be computed. ALUs may be utilized in a different sequence than the sequence described.

Computation time may be reduced by partitioning the computation into 8 simultaneous 128-element dot products.

The example illustrated in FIG. 2 includes 8 vector ALUs, but this is not intended to be limiting. Other examples may include more ALUs or fewer ALUs.

In another example, a first vector and a second vector may be partitioned into two segments. Respective segments of the first vector and the second vector may be coupled to respective ALUs. The first ALU may compute a first partial sum and the second ALU may compute a second partial sum. A controller may control computation of the sum of the first partial sum and the second partial sum to compute the dot product of the first vector and the second vector.

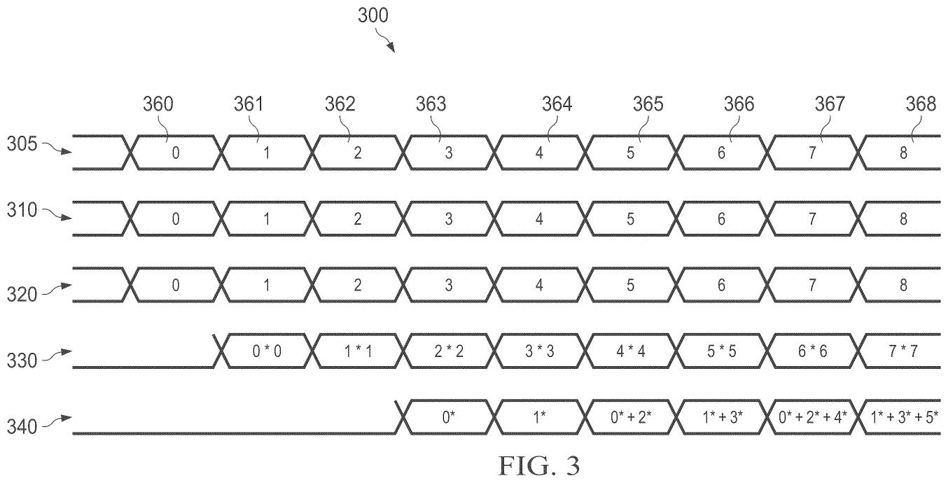

FIG. 3 illustrates a timing diagram 300 of a vector ALU. In one of various examples, timing diagram 300 may represent a timing diagram of one of ALUs 210, 220, 230, 240, 250, 260, 270 and 280 as described and illustrated in reference to FIG. 2. The vector ALU may compute a dot product of a first vector and a second vector. For this illustration, a first vector may also be termed vector A, and a second vector may also be termed vector B.

Trace 305 may represent a count of the clock cycle of operation in the device for computing a dot product. Trace 310 may represent the first vector input of the device, the numbers representing the index of the first vector input. In the example illustrated in FIG. 3, index values may begin at zero, such that a vector input of 1024 samples may be indexed from 0 to 1023. In other examples, index values may begin at one, or may begin with another number. Trace 320 may represent the second vector input of the device, the numbers representing the index of the second vector input. Trace 330 may represent a multiplier output, the multiplier to multiply the values of trace 310 and 320. Trace 340 may represent a feedback output, the feedback output to represent a sum of the multiplier output and a feedback output. The feedback output may also be termed an accumulator.

At time 360, at clock cycle 0, trace 310 may be a first sample of a first vector. This sample may also be represented as A[0] or A₀. Trace 320 may be a first sample of a second vector. This sample may also be represented as B[0] or B₀. Trace 330 and trace 340 may be zero during clock cycle zero as the multiplier and accumulator are multi-cycle operations and do not produce an output until a later clock cycle.

At time 361, at clock cycle 1, trace 310 may be a second sample of a first vector. This sample may also be represented as A[1] or A₁. Trace 320 may be a second sample of a second vector. This sample may also be represented as B[1] or B₁. Trace 330 may be a product of the first sample of the first vector and the first sample of the second vector. The product may be represented as “0*0” in FIG. 3. Trace 340 may be zero during clock cycle 1 as the accumulator is a multi-cycle operation and may not produce an output until a later clock cycle.

At time 362, at clock cycle 2, trace 310 may be a third sample of a first vector. This sample may also be represented as A[2] or A₂. Trace 320 may be a third sample of a second vector. This sample may also be represented as B[2] or B₂. Trace 330 may be a product of the second sample of the first vector and the second sample of the second vector. The product may be represented as “1*1” in FIG. 3. Trace 340 may be zero during clock cycle two as the accumulator is a multi-cycle operation and may not produce an output until a later clock cycle.

At time 363, at clock cycle 3, trace 310 may be a fourth sample of a first vector. This sample may also be represented as A[3] or A₃. Trace 320 may be a fourth sample of a second vector. This sample may also be represented as B[3] or B₃. Trace 330 may be a product of the third sample of the first vector and the third sample of the second vector. The product may be valid at clock cycle 3 because the multiplier is a 2-cycle operation. The product may be represented as “2*2” in FIG. 3. Trace 340 may be a product of the first sample of the first vector and the first sample of the second vector, as the accumulator feedback value is set to zero for this sample. This product may be represented as “0*” in FIG. 3 to make the figure more readable.

At time 364, at clock cycle 4, trace 310 may be a fifth sample of a first vector. This sample may also be represented as A[4] or A₄. Trace 320 may be a fifth sample of a second vector. This sample may also be represented as B[4] or B₄. Trace 330 may be a product of the fourth sample of the first vector and the fourth sample of the second vector. The product may be represented as “3*3” in FIG. 3. Trace 340 may be a product of the second sample of the first vector and the second sample of the second vector, as the accumulator feedback value is set to zero for this sample. This product may be represented as “1*” in FIG. 3 to make the figure more readable.

At time 365, at clock cycle 5, trace 310 may be a sixth sample of a first vector. This sample may also be represented as A[5] or As. Trace 320 may be a sixth sample of a second vector. This sample may also be represented as B[5] or B₅. Trace 330 may be a product of the fifth sample of the first vector and fifth sample of the second vector. The product may be represented as “4*4” in FIG. 3. Trace 340 may be a sum of a product of the third sample of the first vector and the third sample of the second vector and a product of the first sample of the first vector and the first sample of the second vector, as the pipeline operation sets the accumulator feedback value to the output of the accumulator from clock cycle 4. This sum may be represented as “0*+2*” in FIG. 3 to make the figure more readable.

At time 366, at clock cycle 6, trace 310 may be a seventh sample of a first vector. This sample may also be represented as A[6] or A₆. Trace 320 may be a seventh sample of a second vector. This sample may also be represented as B[6] or B₆. Trace 330 may be a product of the sixth sample of the first vector and sixth sample of the second vector. The product may be represented as “5*5” in FIG. 3. Trace 340 may be a sum of a product of the fourth sample of the first vector and the fourth sample of the second vector and a product of the second sample of the first vector and the second sample of the second vector, as the pipeline operation sets the accumulator feedback value to the output of the accumulator from clock cycle 4. This sum may be represented as “1*+3*” in FIG. 3 to make the figure more readable.

At time 367, at clock cycle 7, trace 310 may be an eighth sample of a first vector. This sample may also be represented as A[7] or A₇. Trace 320 may be an eighth sample of a second vector. This sample may also be represented as B[7] or B₇. Trace 330 may be a product of the seventh sample of the first vector and the seventh sample of the second vector. The product may be represented as “6*6” in FIG. 3. Trace 340 may be a sum of the product of the fifth sample of the first vector and the fifth sample of the second vector and a product of the third sample of the first vector and the third sample of the second vector and a product of the first sample of the first vector and the first sample of the second vector, as the pipeline operation sets the accumulator feedback value to the output of the accumulator from clock cycle 6. This sum may be represented as “0*+2*+4*” in FIG. 3 to make the figure more readable. In this manner, trace 340 may accumulate dot product values for even-numbered samples of the first vector and the second vector.

At time 368, at clock cycle 8, trace 310 may be a ninth sample of a first vector. This sample may also be represented as A[8] or As. Trace 320 may be a ninth sample of a second vector. This sample may also be represented as B[8] or B₈. Trace 330 may be a product of the seventh sample of the first vector and the seventh sample of the second vector. The product may be valid at clock cycle 8 due to the fact that the multiplier is a 2-cycle operation. The product may be represented as “7*7” in FIG. 3. Trace 340 may be a sum of a product of the sixth sample of the first vector and the sixth sample of the second vector and a product of the fourth sample of the first vector and the fourth sample of the second vector and a product of the second sample of the first vector and the second sample of the second vector, as the pipeline operation sets the accumulator feedback value to the output of the accumulator from clock cycle 7. This sum may be represented as “1*+3*+5*” in FIG. 3 to make the figure more readable. In this manner, trace 340 may accumulate a dot product values for even-numbered samples of the first vector and the second vector.

Once all input samples have been computed, the accumulator output of even-numbered samples may be added to the accumulator output of odd-numbered samples and may yield the dot product of the input vector, as described and illustrated in reference to FIG. 1.

In this manner, a dot product may be computed in a pipelined device computing even-numbered samples in one stream and odd-numbered samples in second stream.

The example of FIG. 3 is illustrated with specific delays in a multiplier and an accumulator, but this is not intended to be limiting. Other multipliers and accumulators may be utilized.

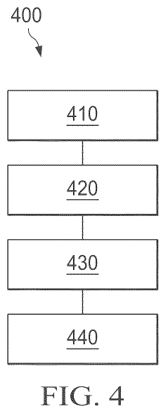

FIG. 4 illustrates a method for computation of a dot product.

At operation 410, a first vector and a second vector may be partitioned into one or more segments. As one of various examples, a first vector may comprise 1024 samples and may be partitioned into 8 segments of 128 samples in each segment, and a second vector may comprise 1024 samples and may be partitioned into 8 segments of 128 samples in each segment.

At operation 420, respective segments of the first vector and the second vector may be input to one or more respective vector ALU devices. As one of various examples, a first segment of a first vector and a first segment of a second vector may be coupled to a first vector ALU device.

At operation 430, the vector ALU devices may compute the dot product of the segments of the first vector and the second vector by pipelining the even-numbered samples and the odd-numbered samples. The vector ALU devices may compute a partial sum of the even-numbered samples during a first clock cycle and may compute a partial sum of the odd-numbered samples during a second clock cycle.

At operation 440, the dot product of the one or more pipelined multiply-accumulator devices may be added to compute the dot product of the full first vector and the full second vector.

1. A device comprising:
a vector arithmetic logic unit (ALU) comprising:
at least two vector inputs;
a multiplier to take input from the at least two vector inputs and to produce a multiplier output comprising a product of the at least two vector inputs;
a first multiplexer to select, as a first multiplexer output, one of the multiplier output, an external input and a delay signal;
a second multiplexer to select, as a second multiplexer output, one of the external input and a feedback output; and
an accumulator to add the first multiplexer output and the second multiplexer output to generate the feedback output.

2. The device as claimed in claim 1, the at least two vector inputs comprising multiple samples, the samples defined by a clock signal input.

3. The device as claimed in claim 2, the second multiplexer to select the external input at a first clock cycle and the feedback output at a second clock cycle.

4. The device as claimed in claim 2, the first multiplexer to select the delay signal at a last clock cycle.

5. The device as claimed in claim 2, the accumulator comprising a pipeline, the pipeline to process even-numbered samples of the at least two vector inputs during a first clock cycle, and to process odd-numbered samples of the at least two vector inputs during a second clock cycle, the second clock cycle after the first clock cycle.

6. A system comprising:
a multiplexer to receive to two or more vector inputs;
at least one vector arithmetic logic unit (ALU) to receive at least one output of the multiplexer, the at least one vector ALU comprising:
at least two ALU vector inputs, the ALU vector inputs provided by the multiplexer;
a multiplier to take input from the at least two ALU vector inputs and to produce a multiplier output comprising a product of the at least two ALU vector inputs;
an accumulator to take input from the multiplier output and a feedback output, wherein the accumulator adds the multiplier output and the feedback output; and
a controller with an output feedback signal coupled to the multiplexer, the controller to receive input from the at least one vector ALU and to generate a feedback signal based on the output of the at least one vector ALU.

7. The system as claimed in claim 6, the two or more vector inputs comprising multiple samples, the samples defined by a clock signal input.

8. The system as claimed in claim 7, the vector ALU to process samples of the at least two vector inputs as a pipeline, the pipeline to process even-numbered samples of the at least two vector inputs during a first clock cycle, and to process odd-numbered samples of the at least two vector inputs during a second clock cycle, the second clock cycle after the first clock cycle.

9. The system as claimed in claim 7, the multiplexer to partition the two or more vector inputs into two or more segments and to couple respective segments to respective at least one vector ALUs.

10. The system as claimed in claim 7, the system comprising two vector inputs and two vector ALUs and the system to compute a first partial sum in a first vector ALU and to compute a second partial sum in a second vector ALU and the controller to couple the first partial sum and the second partial sum to the feedback signal.

11. The system as claimed in claim 10, the controller to couple the first partial sum and the second partial sum to the feedback signal and the multiplexer to couple the first partial sum and the second partial sum to one of the at least two vector ALUs.

12. The system as claimed in claim 11, the one of the at least two vector ALUs to compute the sum of the first partial sum and the second partial sum, the sum comprising a dot product of the first vector input and the second vector input.

13. A method comprising:
partitioning a first vector and a second vector into one or more segments;
coupling the segments of the first vector and the second vector to one or more vector ALUs, the vector ALUs comprising at least a multiplier and an accumulator;
computing a dot product of the segments of the first vector and the second vector by pipelining even-numbered samples and odd-numbered samples within the one or more vector ALUs; and
adding an output of the one or more vector ALUs to compute the dot product of the first vector and the second vector.

14. The method as claimed in claim 13, the adding the dot product of the one or more vector ALUs comprising a controller to feedback outputs of the vector ALUs to the inputs of the vector ALUs.

15. The method as claimed in claim 13, the one or more segments to be comprised of an equal number of samples of the first vector and the second vector.
